(19) United States
(12) Patent Application Publication
(10) Pub. No.: US 2014/0124484 A1
(43) Pub. Date: May 8, 2014

(54) WELD POOL BACKING AT THE EDGE REGION

(71) Applicant: Bernd Burbaum, Falkensee (DE)

(72) Inventor: Bernd Burbaum, Falkensee (DE)

(21) Appl. No.: 14/065,527

(22) Filed: Oct. 29, 2013

(30) Foreign Application Priority Data
Nov. 8, 2012 (EP) 12191770.2

(51) Int. Cl. B23K 26/00; B23K 26/34

(52) U.S. Cl. CPC B23K 26/0093; B23K 26/345
USPC 219/76.14; 29/889.1

(57) ABSTRACT

The application of a peripheral weld before the removal of material produces an enlarged face for the subsequent build-up welding. A process for build-up welding on an outer face having an edge region of a component which is adjoined by a side face is provided. Material is removed to create the outer face but before the material is removed a peripheral weld is effected on the side

### CROSS REFERENCE TO RELATED APPLICATIONS

The present application claims priority to European Patent Office application No. 12191770.2 EP filed Nov. 8, 2012, the entire content of which is hereby incorporated herein by reference.

### FIELD OF INVENTION

The invention relates to the preparation of a face to be welded by weld pool backing at the edge region.

### BACKGROUND OF INVENTION

A successful, uniform build-up of a feathered edge and of the tip requires exact positioning (<50 μm) during welding on the edge (frame contour). In laser welding, the track width is approximately 600 μm. If the edge is not positioned accurately, an undulatory build-up is obtained in the build-up direction, leading to the solidification of grains with a critical grain size (>300 μm) and to cracking On account of the system technology, this small positioning accuracy cannot always be achieved.

### SUMMARY OF INVENTION

It is an object of the invention, therefore, to solve the aforementioned problem.

This object is achieved by a process as claimed in the claims.

The dependent claims list further advantageous measures which can be combined with one another, as desired, in order to achieve further advantages.

### BRIEF DESCRIPTION OF THE DRAWINGS

FIGS. 1-4 show steps of the process according to the invention,

FIG. 5 shows a turbine blade or vane,

FIG. 6 shows a list of superalloys.

The figures and the description represent merely exemplary embodiments of the invention.

### DETAILED DESCRIPTION OF INVENTION

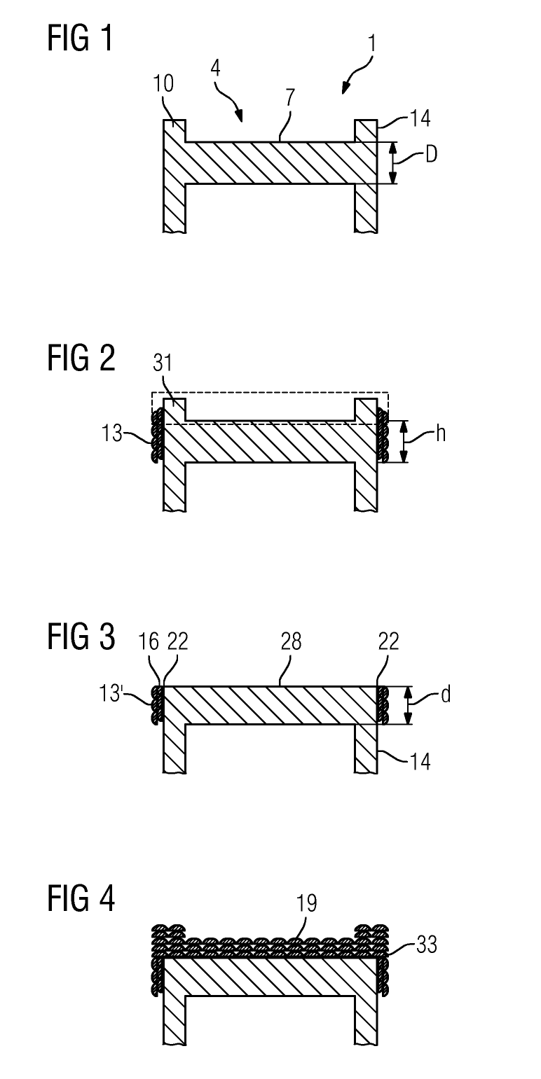

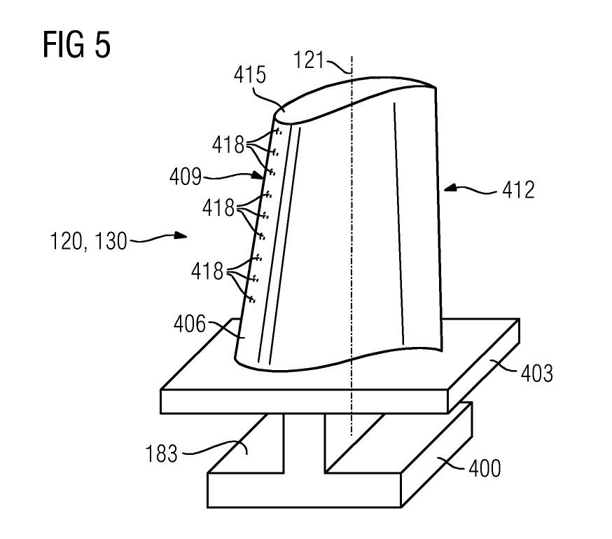

FIG. 1 shows a tip 4 of a component 1, 120, 130 (FIG. 5) with an outer wall 10 and a base 7 therebetween.

The base 7 has a certain thickness D, if the component 1, 120, 130 is hollow.

The outer wall 10 has to be repaired since it has been corroded and/or eroded and/or abraded during use.

According to the prior art, the wall 10 is simply removed and build-up welding takes place.

According to the invention, before the wall 10 is cut off or material 31 is removed (indicated by dashed lines here), a weld 13 is applied to a side face 14 of the component 1. The weld 13 begins at most, in particular at least, level with the base 7 and extends from the height of the base 7 over a certain depth h, which, in this exemplary embodiment, with a thickness D of the base 7, must not be greater than the thickness D.

In the next step, material, in particular the wall 10, is removed in a region 31, this preferably taking place by milling, in order to produce an outer face 28 to which the material 19 is to be applied.

The material can also be removed by a laser and in the same machining apparatus.

As a result of this material removal, the outer wall 10 and/or a part of the base 7 is removed, and therefore in this case the base 7 still has a thickness d≦D here.

The result is the outer face 28, which is extended, at its edge region 22 or at edges 22, by the weld 13 which has been partially cut away, in that the weld 13′ has a virtually planar face 16 beyond the edge 22.

The tip 4 is then built up again by known build-up processes, in particular by laser build-up welding. Owing to the face 16, which constitutes an overhang, welds can be made in the edge region 22 beyond the edge region 22 without welding material sinking down into the edge region 22. Thus, there is then at least one welding bead 33 on the outer face 28 of the component 1, 120, 130 and the part of the weld 13′, without said welding bead 33 sinking down. Then, the base 7 is strengthened again and at least the outer wall 10 is built up again.

It is necessary for the weld 13 to be present only where material is removed and applied in the edge region 22. It can therefore also be peripheral.

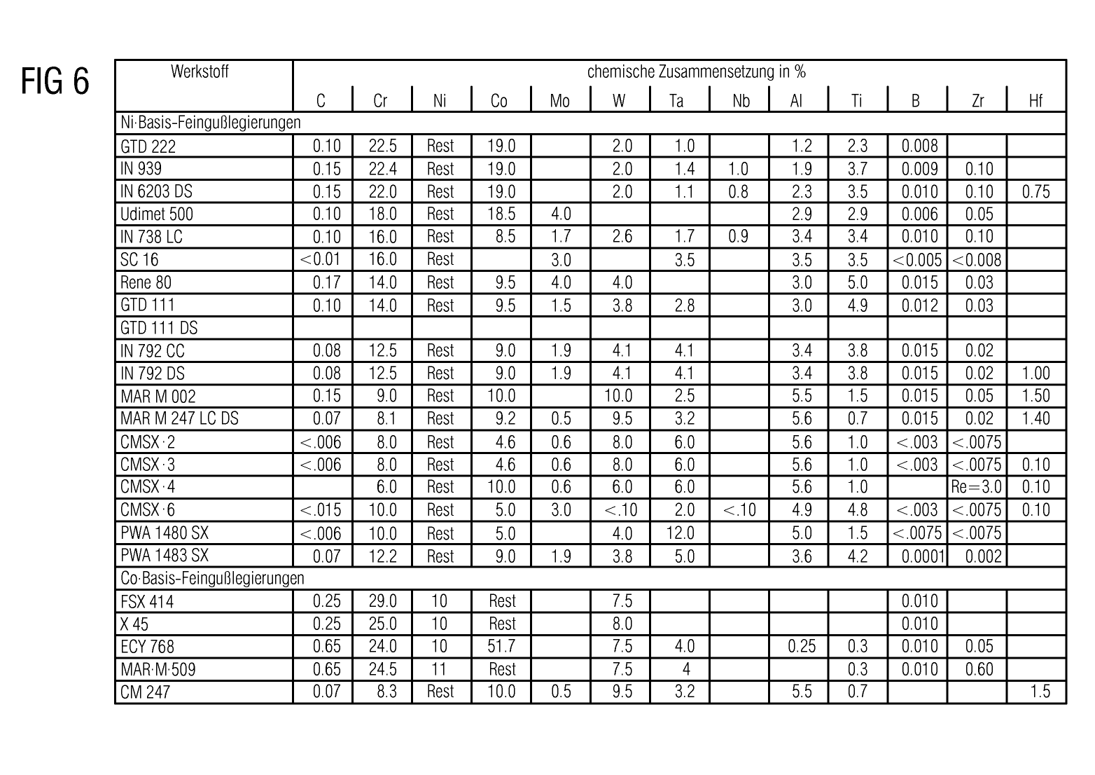

The component 1 is preferably a turbine blade or vane 120, 130 comprising, as the material, a nickel-based or cobalt-based superalloy, in particular as per FIG. 6.

FIG. 5 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, the transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation, e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12A1-0.6Y-3Re or Ni-12Co-21Cr-11Al-0.4Y-2Re or Ni-25 Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer.

Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

1. A process for build-up welding on an outer face, having an edge region, of a component which is adjoined by a side face, the process comprising:
removing material to create the outer face;
before the material is removed, effecting a peripheral weld on the side face in such a way that, after the removal of the material, a part of the peripheral weld is still present on the side face level with the face of the component wherein the part of the peripheral weld extends, by way of an exposed face of the peripheral weld, the outer face of the component which is to be welded beyond the edge region of the face; and
applying material to the face.

2. The process as claimed in claim 1, wherein an outer wall of the component is removed.

3. The process as claimed in claim 1, wherein only one wall of the component is removed.

4. The process as claimed in claim 1, wherein a part of a base between the wall is also removed.

5. The process as claimed in claim 1, wherein a laser build-up welding process is used to produce the peripheral weld and/or the material application.

6. The process as claimed in claim 1, wherein only material for an outer wall is applied.

7. The process as claimed in claim 1, wherein material for a base and an outer wall is applied.

8. The process as claimed in claim 1, wherein at least the part of the peripheral weld is machined after complete application of material.

9. The process as claimed in claim 1, wherein laser build-up welding is used.
